(19) United States
(12) Patent Application Publication
(10) Pub. No.: US 2025/0156946 A1
(43) Pub. Date: May 15, 2025

(54) EXCHANGE OPERATING SYSTEM WHERE SECURITY TOKENS ARE ISSUED AND TRADED

(71) Applicant: In-ki CHOI, Namyangju-si (KR)

(72) Inventor: In-ki CHOI, Namyangju-si (KR)

(21) Appl. No.: 18/389,236

(22) Filed: Nov. 14, 2023

(51) Int. Cl. G06Q 40/04

(52) U.S. Cl. CPC G06Q 40/04

(57) ABSTRACT

The present disclosure relates to an exchange operating system where security tokens are issued and traded, and more specifically, to an exchange operating system where security tokens are issued and traded, in which when security tokens are issued based on stocks in a corporation by splitting into the security tokens, the amount of one security token may be set relatively low compared to one share of stock, thereby naturally encouraging active trading of security tokens through small investors to create an investment environment where small investors can actively invest in companies of their choice, as well as allowing companies to secure investment funds very easily through active trading of security tokens so as to lead to stable operation of companies.

### BACKGROUND OF THE INVENTION

### Field of the Invention

The present disclosure relates to an exchange operating system where security tokens are issued and traded, and more specifically, to an exchange operating system where security tokens are issued and traded, in which when security tokens are issued based on stocks in a corporation by splitting into the security tokens, the amount of one security token may be set relatively low compared to one share of stock, thereby naturally encouraging active trading of security tokens through small investors to create an investment environment where small investors can actively invest in companies of their choice, as well as allowing companies to secure investment funds very easily through active trading of security tokens so as to lead to stable operation of companies.

### Background of the Related Art

In general, stocks are a unit that constitutes the capital of a corporation, and when a shareholder makes an investment, securities corresponding to the stocks held by the shareholder are issued.

These securities (stocks) are actively traded on the Korea Exchange, a stock exchange, but stocks with high prices do not have enough investment by small investors compared to stocks with relatively low prices so as not to create an active investment environment, and due to this phenomenon, corporations with high price ranges have difficulties in securing investment funds, but also in securing competitiveness of the company because its value is undervalued.

In order to solve the foregoing problems, there is a stock split method that issues stocks by dividing them in a certain ratio, but this method has the inconvenience of having to go through a difficult process such as shareholder approval through a general shareholders' meeting and amendment of the articles of incorporation, thereby making it difficult to implement efficiently.

Meanwhile, since cryptocurrency (coin) is a virtual coin issued based on blockchain technology, the uncertainty of investment is very high due to the lack of basis for issuance, and as a result, there were frequent cases where coins were suddenly delisted and investors suffered huge financial losses.

### SUMMARY OF THE INVENTION

The present disclosure is proposed to solve all the problems described above, and an aspect of the present disclosure is to provide an exchange operating system where security tokens are issued and traded, in which when security tokens are issued based on stocks in a corporation by splitting into the security tokens, the amount of one security token may be set relatively low compared to one share of stock, thereby naturally encouraging active trading of security tokens through small investors to create an investment environment where small investors can actively invest in companies of their choice, as well as allowing companies to secure investment funds very easily through active trading of security tokens so as to lead to stable operation of companies.

Furthermore, an aspect of the present disclosure is to provide an exchange operating system where security tokens are issued and traded, in which active trading of security tokens through token exchanges may act as a factor in raising the market price of security tokens while naturally increasing the value of a corporation that issues the security tokens, thereby ensuring excellent competitiveness of the company.

In addition, an aspect of the present disclosure is to provide an exchange operating system where security tokens are issued and traded, in which a token issuing unit may issue security tokens with excellent reliability based on stocks in a corporation to minimize the phenomenon of investors suffering financial damage due to a sudden delisting of security tokens, such as virtual cryptocurrencies with high uncertainty in the past, thereby creating a very stable investment environment.

In order to achieve the foregoing objectives, an exchange operating system where security tokens are issued and traded may include a token exchange formed on the Internet that is accessible through wired/wireless communication networks to trade security tokens through membership subscribers; a member management unit that stores and manages the information of subscribers who access the token exchange to sign up for membership in a database, and allows membership subscribers to create and provide accounts and passwords so as to access the token exchange; a token issuing unit that issues multiple security tokens per share based on stocks in a corporation by splitting into the security tokens, and adds a unique name capable of recognizing the corporation that serves as a basis for issuance to the issued security tokens; a token brokerage unit that provides the issued split security tokens from the token issuing unit to the corporation that makes a request for issuance, registers and exposes, when the corporation makes a request for registration of the issued security tokens to the token exchange, the security tokens with a unique name added thereto on the token exchange to be bought by other subscribers, and brokers a transaction to, when another subscriber who accesses the token exchange makes a request to buy security tokens and pays a cost, allow the security tokens owned by the corporation to be provided to a buyer (subscriber), and the cost paid by the buyer to be provided to the corporation; and a fee determination unit that generates a predetermined fee in the process of trading security tokens through the token brokerage unit.

Furthermore, the fee determination unit may determine and charge a predetermined fee in the process of trading security tokens through the token exchange, wherein a fee on a seller's side selling security tokens is set in a range of 0 to 2% of a profit from a market gain through the sale of security tokens, and the profit is converted into a rate of return and a fee is charged based on the rate of return, and a range of 0 to 200% is set for the rate of return, and the rate of return in the range section of 0 to 200% of the rate of return is divided into at least two or more sections so as to be sequentially set as a first grade, a second grade, . . . , and an n-th grade, and then the fee for each grade is set differently in proportion to the rate of return for each grade, and when trading security tokens, the seller pays an appropriate fee set for a grade corresponding to the rate of return on the market gain through the sale of security tokens in such a manner that the seller's fee burden on the sale of security tokens can be minimized.

Furthermore, the token issuing unit may ensure that prices for initial security tokens issued based on stocks in corporations are issued uniformly at a specific amount.

Furthermore, the token issuing unit may add a corporate name to security tokens issued based on stocks in the corporation as a unique name so as to recognize the corporation, wherein the token issuing unit issues security tokens through a search process of searching for whether there are security tokens that have been issued as stocks in a corporation with the same name as the corporate name of the stocks to be issued as security tokens, and an issuance process of issuing security tokens with the name of the corporation by means of the unique name when there are no security tokens that have been issued as the stocks in the corporation with the same name as the corporate name of the stocks to be issued as security tokens through the search process, and issuing security tokens with the name of the corporation by means of the unique name as well as issuing security tokens with a unique serial number added thereto when there are security tokens that have been issued as the stocks in the corporation with the same name as the corporate name of the stocks to be issued as security tokens through the search process, and the unique name and the unique serial number added to the security tokens are both exposed to the public on the token exchange.

As described above, according to an exchange operating system where security tokens are issued and traded in accordance with the present disclosure, when security tokens are issued based on stocks in a corporation by splitting into the security tokens, the amount of one security token may be set relatively low compared to one share of stock, thereby having an effect of naturally encouraging active trading of security tokens through small investors to create an investment environment where small investors can actively invest in companies of their choice, as well as allowing companies to secure investment funds very easily through active trading of security tokens so as to lead to stable operation of companies.

Furthermore, active trading of security tokens through token exchanges may act as a factor in raising the market price of security tokens while naturally increasing the value of a corporation that issues the security tokens, thereby having an effect of ensuring excellent competitiveness of the company.

In addition, a token issuing unit may issue security tokens with excellent reliability based on stocks in a corporation to minimize the phenomenon of investors suffering financial damage due to a sudden delisting of security tokens, such as virtual cryptocurrencies with high uncertainty in the past, thereby having an effect of creating a very stable investment environment.

### BRIEF DESCRIPTION OF THE DRAWINGS

FIG. 1 is a conceptual diagram of an exchange operating system where security tokens are issued and traded according to an embodiment of the present disclosure.

FIGS. 2A-2D are diagrams for explaining the exchange operating system where security tokens are issued and traded as shown in FIG. 1.

FIG. 3 is a diagram for explaining an exchange operating system where security tokens are issued and traded according to another embodiment of the present disclosure.

FIG. 4 is a diagram for explaining an exchange operating system where security tokens are issued and traded according to still another embodiment of the present disclosure.

### DESCRIPTION OF SYMBOLS

| | |
|---|---|
| 1: Terminal | |
| 10: Token exchange | 20: Member management unit |
| 21: Database | 30: Token issuing unit |
| 31: Unique name | 32: Unique serial number |
| 40: Token brokerage unit | 50: Fee determination unit |
| S10: Search process | S20: Issuance process |
| 100: Exchange operating system where | |
| security tokens are issued and traded | |

### DETAILED DESCRIPTION OF THE PREFERRED EMBODIMENT

An exchange operating system where security tokens are issued and traded according to a preferred embodiment of the present disclosure will be described in detail based on the accompanying drawings. Detailed descriptions of well-known functions and configurations that are determined to unnecessarily obscure the gist of the present disclosure will be omitted.

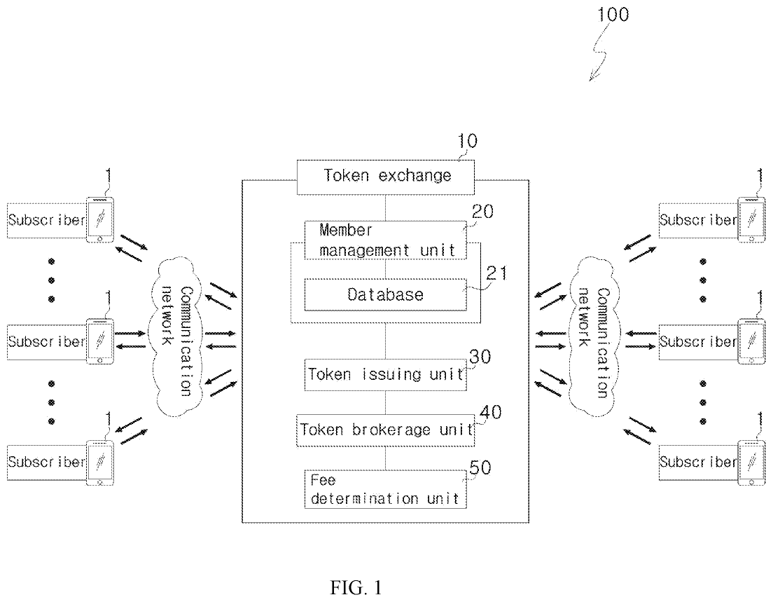

FIGS. 1 to 4 show an exchange operating system where security tokens are issued and traded according to an embodiment of the present disclosure, in which FIGS. 1 to 4 show a conceptual diagram of an exchange operating system where security tokens are issued and traded according to an embodiment of the present disclosure, a diagram for explaining the exchange operating system where security tokens are issued and traded as shown in FIG. 1, a diagram for explaining an exchange operating system where security tokens are issued and traded according to another embodiment of the present disclosure, and a diagram for explaining an exchange operating system where security tokens are issued and traded according to still another embodiment of the present disclosure, respectively.

As shown in the drawings, the exchange operating system 100 in which security tokens are issued and traded according to an embodiment of the present disclosure includes a token exchange 10, a member management unit 20, a token issuing unit 30, a token brokerage unit 40, and a fee determination unit 50.

As shown in FIG. 1, the token exchange 10, which is a website formed on the Internet that is accessible through wired/wireless communication networks, is an exchange built to allow various security tokens registered through membership subscribers to be exposed and easily traded through other subscribers.

As shown in FIG. 1, the member management unit 20 stores and manages the information of subscribers who access the token exchange 10 to sign up for membership in a database 21, and allows membership subscribers to create and provide accounts and passwords so as to access the token exchange 10.

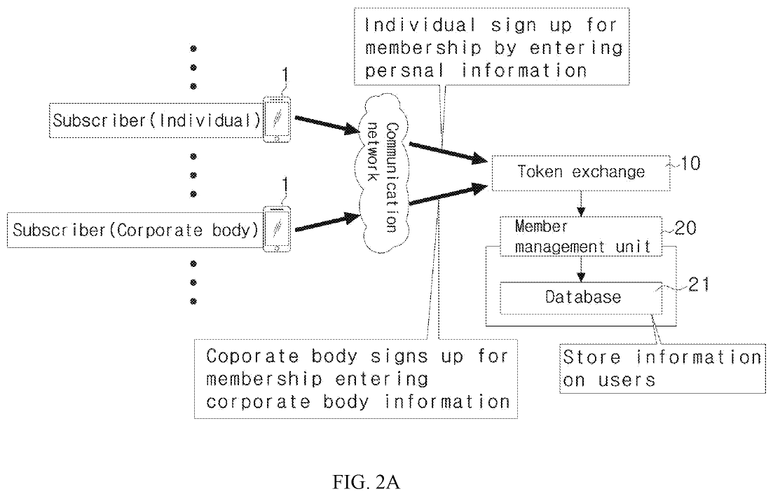

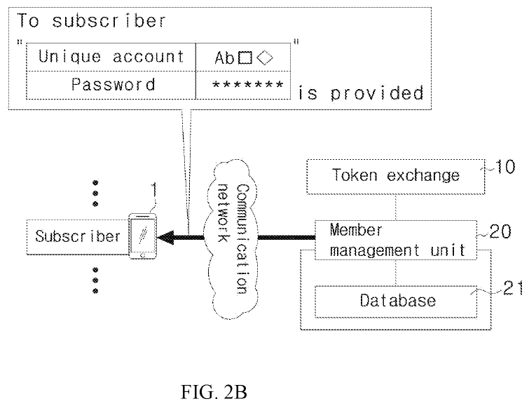

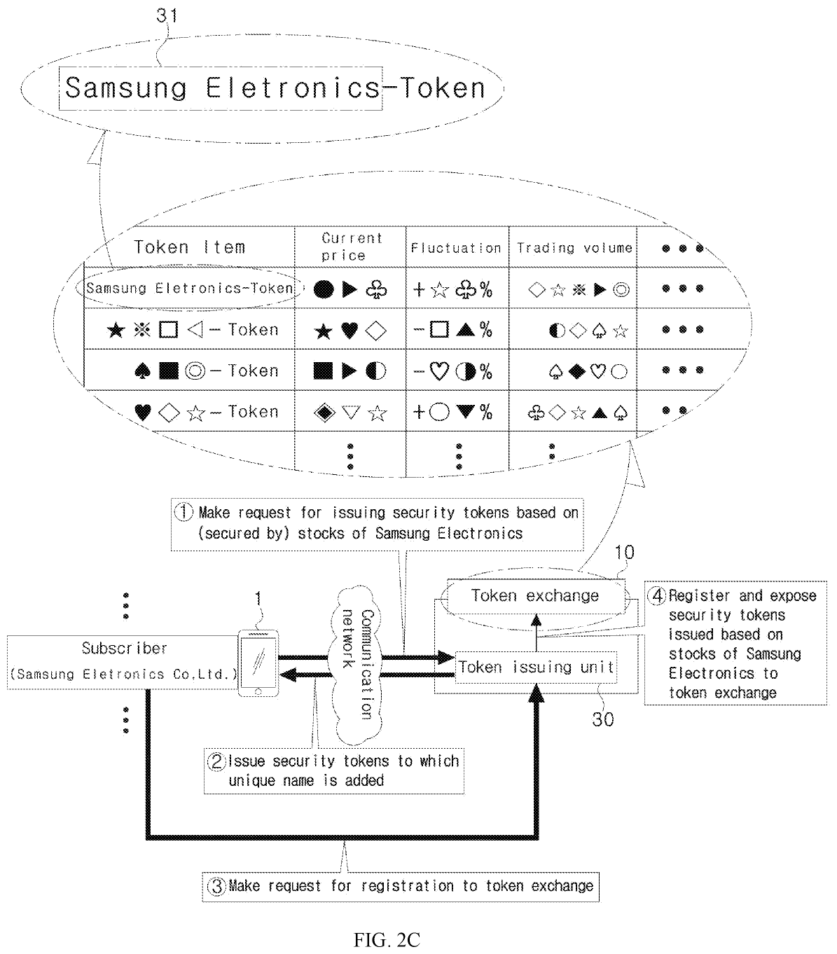

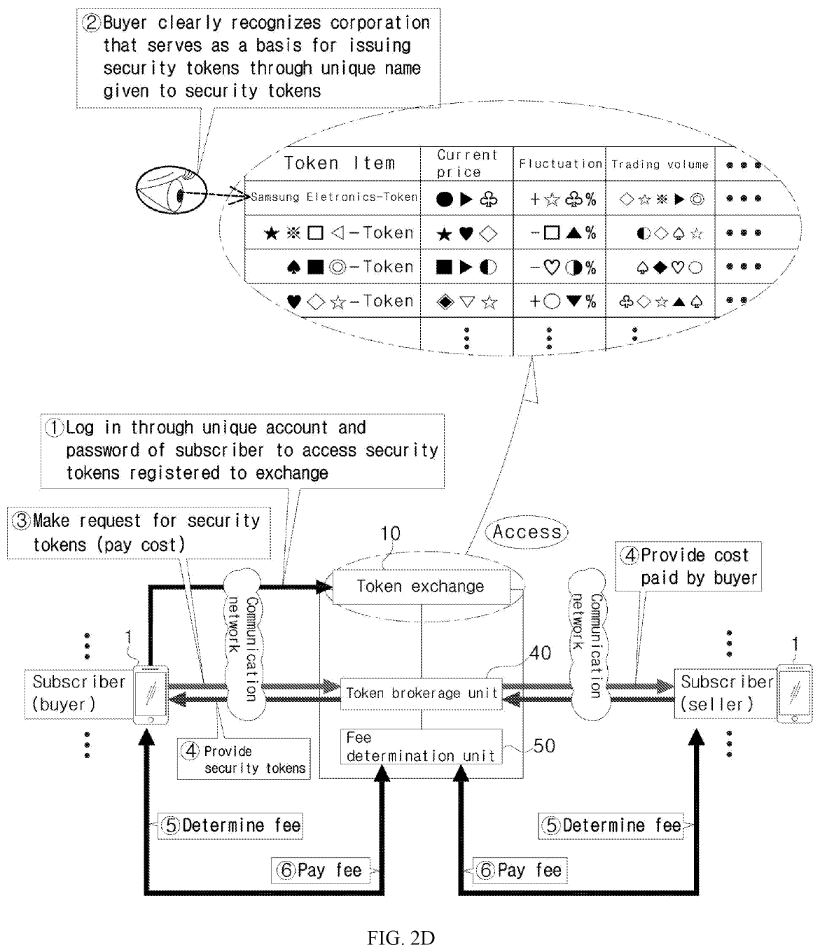

That is, as shown in FIG. 2A, a user (individual) who wishes to use security token trading through the token exchange 10 may access the token exchange 10 through a terminal 1 such as a typical PC or smartphone to sign up for membership, and in this case, during the process of signing up as a member on the token exchange 10, personal information such as a subscriber's name, a gender, a resident registration number, and an address, as well as a phone number, an email address, and bank account information in the subscriber's name are input, and the input information is stored and managed in the database 21 of the member management unit 20.

Of course, a user who is a corporate body may also sign up as a member, and in this case, information of the corporate body, such as a name of the corporation, a corporation registration number, a location address, a phone number, an email address, and bank account information in the name of the corporation may be input, and the input information is stored and managed in the database 21.

Then, as shown in FIG. 2B, the member management unit 20 creates and provides a unique account and password to the subscriber who has completed membership registration so that the subscriber can engage in activities on the token exchange.

Here, the unique account and password given to the subscriber are means for accessing and logging into the token exchange 10, and through such login, security tokens may be conveniently traded on the token exchange 10.

As shown in FIG. 1, the token issuing unit 30 issues multiple security tokens per share based on stocks in a corporation by splitting into the security tokens, and the issued security token are given a unique name 31 capable of recognizing the corporation that serves as a basis for issuance.

That is, as shown in FIG. 2C, for the issuance of security tokens, the security tokens may be issued based on stocks (legally confirmed stocks) shown on a registered copy of the corporation, specifically secured by the stocks, thereby issuing highly reliable security tokens.

Of course, security tokens issued based on stocks in a corporation may be issued by adding a unique name 31 capable of recognizing the corporation thereto, thereby allowing anyone to easily recognize and trade the corporation that serves as a basis for issuing security tokens registered and traded on the token exchange 10.

For an example, security tokens issued based on Samsung Electronics' stocks are issued as “Samsung Electronics-Tokens” by adding the company's name thereto as the unique name 31 so as to allow anyone to easily recognize the company that serves as a basis for the issued security tokens, but the unique name 31 given to the security token is not, of course, limited to the company name.

Meanwhile, when security tokens are issued based on stocks in a corporation by splitting into the security tokens as described above, the following effects may be expected.

First, due to the nature of issuing one share of stock by splitting into multiple security tokens, the amount of one security token may be set relatively lower than the amount of one share of stock so as to create an environment in which small investors can actively invest, thereby leading to active investment.

For an example, when a stock worth 1,000,000 won per share is issued by splitting into 10,000 security tokens, one security token is issued for the amount of 100 won, which naturally creates an environment in which small investors can very actively invest.

Second, on the token exchange 10 where an active investment environment is created as described above, a corporation may issue stocks by splitting into security tokens so as to very easily and quickly raise investment funds for the company, thereby leading to stable operation of the company.

Third, the active trading of security tokens as described above may act as a factor in raising the market price of security tokens, and when the market price of security tokens rises, the value of a corporation that issues the security tokens may increase, thereby ensuring excellent competitiveness of the company.

As shown in FIG. 1, the token brokerage unit 40 provides the issued split security tokens from the token issuing unit 30 to the corporation that makes a request for issuance, registers and exposes, when the corporation makes a request for registration of the issued security tokens to the token exchange 10, the security tokens with a unique name 31 added thereto on the token exchange 10 to be bought by other subscribers, and brokers a transaction to, when another subscriber who accesses the token exchange 10 makes a request to buy security tokens and pays a cost, allow the security tokens owned by the corporation to be provided to a buyer (subscriber), and the cost paid by the buyer to be provided to the corporation.

That is, as shown in FIG. 2D, when the trading of security tokens registered on the token exchange 10 is carried out, the token brokerage unit 40 actually provides security tokens owned by the corporation to the buyer while at the same time providing a purchase cost paid by the buyer to the corporation so as to encourage an actual transaction of the security tokens, thereby preventing in advance the problem of coin loss that occurs when encouraging a virtual coin transaction while actual coins are stored in a conventional coin exchange.

Here, the purchase of the security tokens is basically made based on cash, but of course, in order to create an efficient investment environment, trading may be carried out through highly reliable cryptocurrency (Bitcoin, Ethereum, etc.).

As shown in FIG. 1, the fee determination unit 50 generates a predetermined fee in the process of trading security tokens through the token brokerage unit 40.

That is, as shown in FIG. 2D, the fee determination unit 50 determines and charges a predetermined fee in the process of trading security tokens through the token exchange 10.

A fee on a seller's side selling security tokens is set in a range of 0 to 2% of a profit from a market gain through the sale of security tokens, and the profit is converted into a rate of return and a fee is charged based on the rate of return.

A range of 0 to 200% is set for the rate of return, and the rate of return in the range section of 0 to 200% of the rate of return is divided into at least two or more sections so as to be sequentially set as a first grade, a second grade, . . . , and an n-th grade, and then the fee for each grade is set differently in proportion to the rate of return for each grade.

In summary, the fee determination unit 50 sets the rate of return on the market gain through the sale of security tokens in a range of 0 to 200%, wherein for convenience of explanation, as shown in [Table 1] below, a section for the rate of return of 0 to 200% is divided into a section of 0% or less, a section of 0 to 50%, a section of 50 to 100%, a section of 100 to 150%, and a section of 150 to 200% or more, and the divided sections are sequentially divided into a first grade, a second grade, a third grade, a fourth grade and a fifth grade, and a fee of 0%, a fee of 0.5%, a fee of 1%, a fee of 1.5%, and a fee of 2% are set differently for the first grade, the second grade, the third grade, the fourth grade, and the fifth grade, respectively.

Here, divided sections of grades, and ranges of rates of returns and fees for each section are arbitrarily set for convenience of explanation, and the rates of return and fees may be set in various arbitrary range sections, but for ease of explanation, the rates of return and fees for a total of five grades are specifically set.

TABLE 1

| Grade | 1st grade | 2nd grade | 3rd grade | 4th grade | 5th grade |
|---|---|---|---|---|---|
| Rate of | Less than | 0% to | 50% to | 100% to | 150% to |
| return | 0% | 50% | 100% | 150% | 200% or |
| | | | | | more |
| Fee | 0% | 0.5% | 1% | 1.5% | 2% |

For an example, when a seller sells security tokens worth. 100 million won at 120 million won, the market gain through the sale of the security tokens is 20 million won, which is a rate of return of 20%, and thus the seller will pay a fee of 0.5% of the profit corresponding to the second grade.

For another example, when seller sells security tokens worth 100 million won at 280 million won, the market gain through the sale of the security tokens is 180 million won, which is a rate of return of 180%, and thus the seller will pay a fee of 2% of the profit corresponding to the fifth grade.

If a seller sells security tokens worth 100 million won at 80 million won, then the market gain through the sale of the security tokens is a loss of 20 million won, which is a rate of return of −20%, and thus the seller will not pay a fee for the sale of the security tokens corresponding to the first grade.

Therefore, a seller who sells security tokens pays a small fee when a somewhat low rate of return is generated through the sale of security tokens, and pays a somewhat high fee when a somewhat high rate of return generated so as to ensure fairness in charging fees, but when a loss is generated through the sale of security tokens, a fee is not charged (exempted) to reduce the economic burden on the seller, thereby leading to rational operation of the exchange.

Of course, it is natural that a predetermined rate of fee (fixed fee) determined by the exchange may be charged to a buyer who has bought security tokens.

Meanwhile, the token issuing unit 30 ensures that prices for initial security tokens issued based on stocks in corporations are issued uniformly at a specific amount.

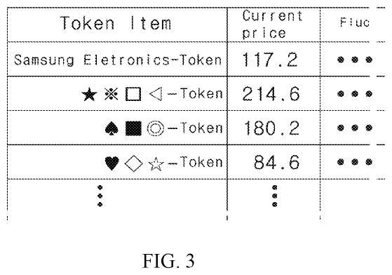

For an example, as shown in FIG. 3, when the amount of all initial security tokens issued through the token issuing unit 30 is uniformly specified as 100 won, in case where the market prices of various types of security tokens traded on the token exchange 10 are low based on 100 won, the soundness or value of the company that serves as a basis for the security tokens may be determined to be somewhat low, and conversely, in case where they are high based on 100 won, the soundness or value of the company that serves as a basis for the security tokens may be determined to be somewhat high.

Of course, the foregoing determination criterion may not be all that can accurately determine the soundness or value of the company, but may be one criterion that can determine the soundness or value of the company, and therefore, even beginners in trading may easily and efficiently find companies they want to invest in based on the criterion so as to create an environment in which novice investors can easily invest, thereby leading to very active investment.

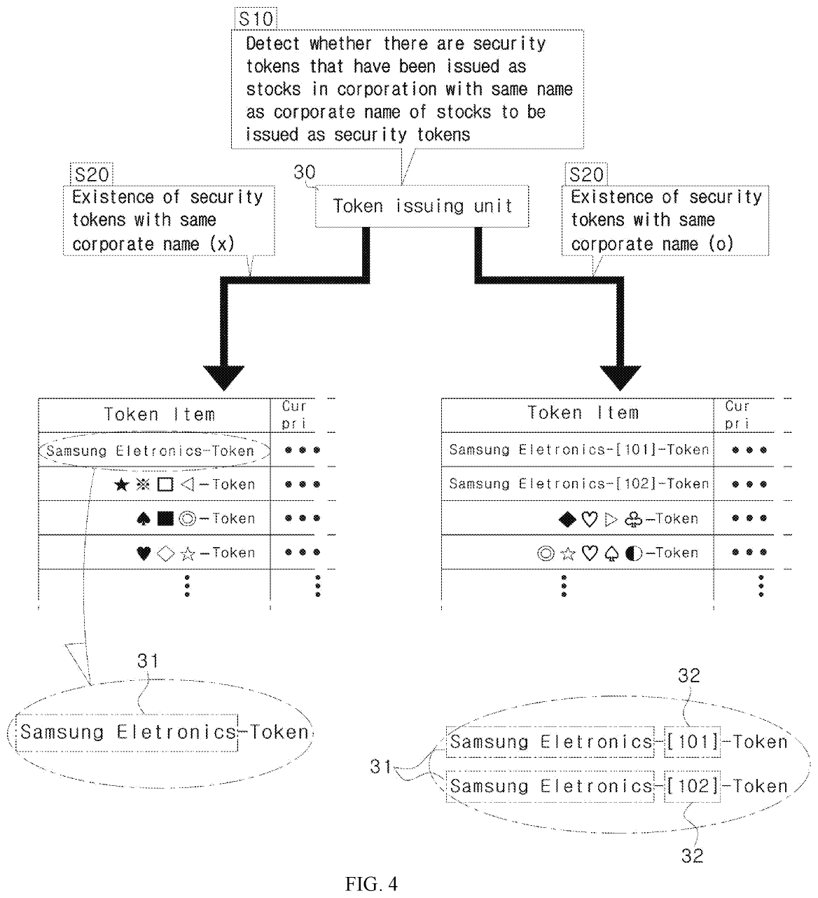

Meanwhile, as shown in FIG. 4, the token issuing unit 30 adds a corporate name to security tokens issued based on stocks in the corporation as a unique name 31 so as to recognize the corporation.

The token issuing unit 30 issues security tokens through a search process S10 of searching for whether there are security tokens that have been issued as stocks in a corporation with the same name as the corporate name of the stocks to be issued as security tokens, and an issuance process S20 of issuing security tokens with the name of the corporation by means of the unique name 31 when there are no security tokens that have been issued as the stocks in the corporation with the same name as the corporate name of the stocks to be issued as security tokens through the search process S10, and issuing security tokens with the name of the corporation by means of the unique name 31 as well as issuing security tokens with a unique serial number 32 added thereto when there are security tokens that have been issued as the stocks in the corporation with the same name as the corporate name of the stocks to be issued as security tokens through the search process S10.

The unique name 31 and the unique serial number 32 added to the security tokens are both exposed to the public on the token exchange 10.

Here, when issuing security tokens based on stocks in a corporation, the token issuing unit 30 adds a unique name 31 thereto so as to allow anyone to clearly recognize the corporation of the stocks that serve as a basis for the security tokens.

However, security tokens issued through stocks in multiple companies with the same company name may have the same unique name 31, and therefore, each stock company may not be clearly distinguished based on the unique name 31 given to each security token.

That is, the token issuing unit 30 may search for whether there are security tokens that have been issued as stocks in a corporation with the same name as the corporate name of the stocks to be issued as security tokens, and then issue security tokens with the name of the corporation by means of the unique name 31 as well as issue security tokens with a unique serial number 32 added thereto when there are security tokens that have been issued as the stocks in the corporation with the same name as the corporate name of the stocks to be issued as security tokens, thereby, even when the unique name 31 is the same, allowing the corporation of each stock that serves as a basis for the security tokens to be clearly distinguished and recognized.

Therefore, even when the unique names 31 of the security tokens registered and exposed in the token exchange 10 are the same, the corporation of the stocks that serve as a basis for the security tokens may be clearly distinguished and recognized through the unique serial number 32 for the investors (buyers) so as to prevent in advance the problem of mistakenly investing in the corporation of the stocks that serve as a basis for the security tokens, thereby leading to efficient trading of the security tokens.

In the exchange operating system 100 where security tokens are issued and traded in accordance with the present disclosure including elements as described above, when security tokens are issued based on stocks in a corporation by splitting into the security tokens, the amount of one security token may be set relatively low compared to one share of stock, thereby having an effect of naturally encouraging active trading of security tokens through small investors to create an investment environment where small investors can actively invest in companies of their choice, as well as allowing companies to secure investment funds very easily through active trading of security tokens so as to lead to stable operation of companies.

Furthermore, active trading of security tokens through the token exchange 10 may act as a factor in raising the market price of security tokens while naturally increasing the value of a corporation that issues the security tokens, thereby having an effect of ensuring excellent competitiveness of the company.

In addition, the token issuing unit 30 may issue security tokens with excellent reliability based on stocks in a corporation to minimize the phenomenon of investors suffering financial damage due to a sudden delisting of security tokens, such as virtual cryptocurrencies with high uncertainty in the past, thereby having an effect of creating a very stable investment environment.

Security tokens will be issued and traded as follows through the exchange operating system 100 where security tokens are issued and traded according to the embodiment of the present disclosure having the foregoing configuration.

First, as shown in FIG. 2A, a user who wishes to use the token exchange 10 on the Internet accesses the token exchange 10 through a wired/wireless communication network to sign up for membership by entering his or her personal information. Of course, when the user is a corporate body, he or she signs up for membership by entering information relevant to the corporate body.

Here, the information of the membership subscriber is stored and managed in the database 21 of the member management unit 20.

Then, as shown in FIG. 2B, the member management unit 20 creates and provides a unique account and password to the subscriber to access the token exchange 10 so as to engage in activities.

Meanwhile, as shown in FIG. 2C, the token issuing unit 30 may issue security tokens with a unique name of a corporation based on stocks in the corporation owned by the membership subscriber, and the security tokens issued in this way are registered and exposed to the token exchange 10 so as to be traded by other membership subscribers.

Then, as shown in FIG. 2D, when the purchase of security tokens exposed to the token exchange 10 is requested by a membership subscriber (buyer), the token brokerage unit 40 encourages a direct transaction between a buyer and a seller to stably carry out the trading of security tokens.

Here, the buyer may basically buy security tokens based on cash, but may also be encouraged to carry out trading through typical cryptocurrency (coin), thereby allowing foreigners to easily carry out the trading of security tokens overseas.

When the trading of security tokens is carried out between the buyer and the seller as described above, the fee determination unit 50 may charge a reasonable fee to the seller, and a predetermined fixed rate of fee may be charged to the buyer.

The present disclosure has been described with reference to embodiments shown in the accompanying drawings, but is illustrative, and is not limited to the above-described embodiments, and it should be appreciated by those skilled in the art that various modifications and embodiments equivalent thereto can be made therefrom. In addition, modifications can, of course, be made by those skilled in the art without departing from the scope of the present disclosure. Therefore, the scope of the claims in the present disclosure should not be defined within the scope of the detailed description but will be limited by the following claims and the technical concept thereof.

What is claimed is:

1. An exchange operating system where security tokens are issued and traded, the exchange operating system comprising:
a token exchange 10 formed on the Internet that is accessible through wired/wireless communication networks to trade security tokens through membership subscribers;
a member management unit 20 that stores and manages the information of subscribers who access the token exchange 10 to sign up for membership in a database 21, and allows membership subscribers to create and provide accounts and passwords so as to access the token exchange 10;
a token issuing unit 30 that issues multiple security tokens per share based on stocks in a corporation by splitting into the security tokens, and adds a unique name 31 capable of recognizing the corporation that serves as a basis for issuance to the issued security tokens;
a token brokerage unit 40 that provides the issued split security tokens from the token issuing unit 30 to the corporation that makes a request for issuance, registers and exposes, when the corporation makes a request for registration of the issued security tokens to the token exchange 10, the security tokens with a unique name 31 added thereto on the token exchange 10 to be bought by other subscribers, and brokers a transaction to, when another subscriber who accesses the token exchange 10 makes a request to purchase security tokens and pays a cost, allow the security tokens owned by the corporation to be provided to a buyer (subscriber), and the cost paid by the buyer to be provided to the corporation; and
a fee determination unit 50 that generates a predetermined fee in the process of trading security tokens through the token brokerage unit 40.

2. The exchange operating system of claim 1, wherein the fee determination unit 50 determines and charges a predetermined fee in the process of trading security tokens through the token exchange 10,
wherein a fee on a seller's side selling security tokens is set in a range of 0 to 2% of a profit from a market gain through the sale of security tokens, and the profit is converted into a rate of return and a fee is charged based on the rate of return,
wherein a range of 0 to 200% is set for the rate of return, and the rate of return in the range section of 0 to 200% of the rate of return is divided into at least two or more sections so as to be sequentially set as a first grade, a second grade, . . . , and an n-th grade, and then the fee for each grade is set differently in proportion to the rate of return for each grade, and
wherein when trading security tokens, the seller pays an appropriate fee set for a grade corresponding to the rate of return on the market gain through the sale of security tokens in such a manner that the seller's fee burden on the sale of security tokens can be minimized.

3. The exchange operating system of claim 1, wherein the token issuing unit 30 ensures that prices for initial security tokens issued based on stocks in corporations are issued uniformly at a specific amount.

4. The exchange operating system of claim 1, wherein the token issuing unit 30 adds a corporate name to security tokens issued based on stocks in the corporation as a unique name 31 so as to recognize the corporation,
wherein the token issuing unit 30 issues security tokens through a search process S10 of searching for whether there are security tokens that have been issued as stocks in a corporation with the same name as the corporate name of the stocks to be issued as security tokens, and an issuance process S20 of issuing security tokens with the name of the corporation by means of the unique name 31 when there are no security tokens that have been issued as the stocks in the corporation with the same name as the corporate name of the stocks to be issued as security tokens through the search process S10, and issuing security tokens with the name of the corporation by means of the unique name 31 as well as issuing security tokens with a unique serial number 32 added thereto when there are security tokens that have been issued as the stocks in the corporation with the same name as the corporate name of the stocks to be issued as security tokens through the search process S10, and
wherein the unique name 31 and the unique serial number 32 added to the security tokens are both exposed to the public on the token exchange 10.
